(19) United States
(12) Patent Application Publication
(10) Pub. No.: US 2007/0046934 A1
(43) Pub. Date: Mar. 1, 2007

(54) Multi-function laser induced breakdown spectroscopy and laser ablation material analysis system and method

(75) Inventor: John W. Roy, Del Mar, CA (US)

Correspondence Address: HAYNES BEFFEL & WOLFELD LLP, P O BOX 366, HALF MOON BAY, CA, 94019, US

(73) Assignee: New Wave Research, Inc., Fremont, CA (US)

(21) Appl. No.: 11/213,057

(22) Filed: Aug. 26, 2005

(51) Int. Cl. G01J 3/30

(52) U.S. Cl. 356/318; 356/72

(57) ABSTRACT

A system is described that combines an optical spectrometer and a particle analysis spectrometer for simultaneous and/or sequential analysis of a sample placed in a sample chamber. A laser resonator generates a light beam on the sample in the sample chamber to produce a plasma formation and an aerosol formation. The optical spectrometer (spectrophotometer) analyzes a plasma formation generated from the sample surface of the sample, qualifies and/or quantifies and records chemical data of the sample. The particle analysis spectrometer analyzes an aerosol formation generated from the sample in the sample chamber, and qualifies and/or quantifies and records data of the sample. The combination of the optical spectrometer and the particle analysis spectrometer in the system enables simultaneous and/or sequential analysis, qualification and/or quantification, and recording of the chemical and physical data derived from the transfer of laser energy into a solid, liquid or gas.

### BACKGROUND OF THE INVENTION

1. Field of the Invention

The present invention relates generally to laser systems, and more particularly, to detection and analysis of a sample using laser induced breakdown spectroscopy and laser ablation.

2. Description of Related Art

Laser induced breakdown spectroscopy (LIBS) is a device used for material analysis to determine the chemical composition of solids, liquids and gases. Laboratory LIBS systems have been deployed for industrial and government applications for detection and analysis of chemical agents. Laser ablation for inductively coupled plasma mass spectrometry (LA-ICP-MS) and laser ablation for inductively coupled plasma optical emissions spectrometry (LA-ICP-OES) also are used for material analysis, and provide higher accuracy and precision than has been demonstrated using LIBS. However, LIBS equipment is considerably less expensive to own and operate than laser ablation equipment, resulting in an increasing demand for certifiable methods to test various materials with LIBS.

Accordingly, it is desirable to design a system that provides a common platform for conducting different test methods as a means to validate LIBS data or as a multiple-function test platform.

### SUMMARY OF THE INVENTION

The present invention provides a system that combines an optical spectrometer and a particle analysis spectrometer for simultaneous analysis of a sample placed in a sample chamber. A laser resonator generates a light beam on the sample in the sample chamber to produce a plasma formation and an aerosol formation. The optical spectrometer analyzes a plasma formation generated from the sample surface of the sample, and qualifies, quantifies and records chemical data of the sample. The particle analysis spectrometer analyzes an aerosol formation generated from the sample in the sample chamber, and qualifies, quantifies and records data of the sample. The combination of the optical spectrometer and the particle analysis spectrometer in the system enables simultaneous analysis, qualification, quantification, and recordation of the chemical and physical data derived from the transfer of laser energy into a solid, liquid or gas.

The optical spectrometer and the particle analysis spectrometer utilize continuous and/or pulsed lasers to heat and/or ionize the sample to determine its chemical composition. The analysis by the optical spectrometer and the analysis by the particle analysis spectrometer can occur either simultaneously or sequentially. Firing one or more lasers sequentially or simultaneously for detecting the emissions which minimizes variations that can occur between laser pulses or when a laser emits a continuous output for a protracted duration.

In a first embodiment, the present invention describes a LA-LIBS system in a single-laser configuration that generates a single pulse to the sample. In a second embodiment, the present invention describes a LA-LIBS system in a two-laser configuration that generates two or more pulses to the same sample.

Broadly stated, a system comprises a sample chamber adapted to hold a sample; a source of radiation and optics for delivering the radiation to the sample to produce a laser induced plasma formation and a laser induced aerosol formation; an optical spectrometer for receiving a spectrum of light emitted from the laser induced plasma formation; and a particle processor for receiving the laser induced aerosol formation or a derivative of the laser induced aerosol formation through a transport coupling between the sample chamber and the particle processor; wherein the optical spectrometer analyzes chemical data from the laser induced plasma formation while the particle processor analyzes data from the laser induced aerosol formation.

Advantageously, the present invention provides a system that simultaneously produces a plasma formation and an aerosol formation from the same sample. In addition, the present invention improves the accuracy and repeatability of the test results.

The structures and methods regarding to the present invention are disclosed in the detailed description below. This summary does not purport to define the invention. The invention is defined by the claims. These and other embodiments, features, aspects, and advantages of the invention will become better understood with regard to the following description, appended claims and accompanying drawings.

### BRIEF DESCRIPTION OF THE DRAWINGS

FIG. 1 is a simplified architectural diagram illustrating a first embodiment of a LA-LIBS system in a single-laser configuration in accordance with the present invention.

FIG. 2 is a simplified architectural diagram illustrating a second embodiment of a LA-LIBS system in a two-laser configuration in accordance with the present invention.

FIG. 3 is a simplified flow diagram illustrating functional processes and options at selected elements in a LA-LIBS system in accordance with the present invention.

FIG. 4 is a flow diagram illustrating the process performed by elements in a LA-LIBS system in accordance with the present invention.

FIG. 5 is a flow diagram illustrating the process in conducting a LA-LIBS analysis in accordance with the present invention.

### DETAILED DESCRIPTION OF EMBODIMENTS OF THE INVENTION

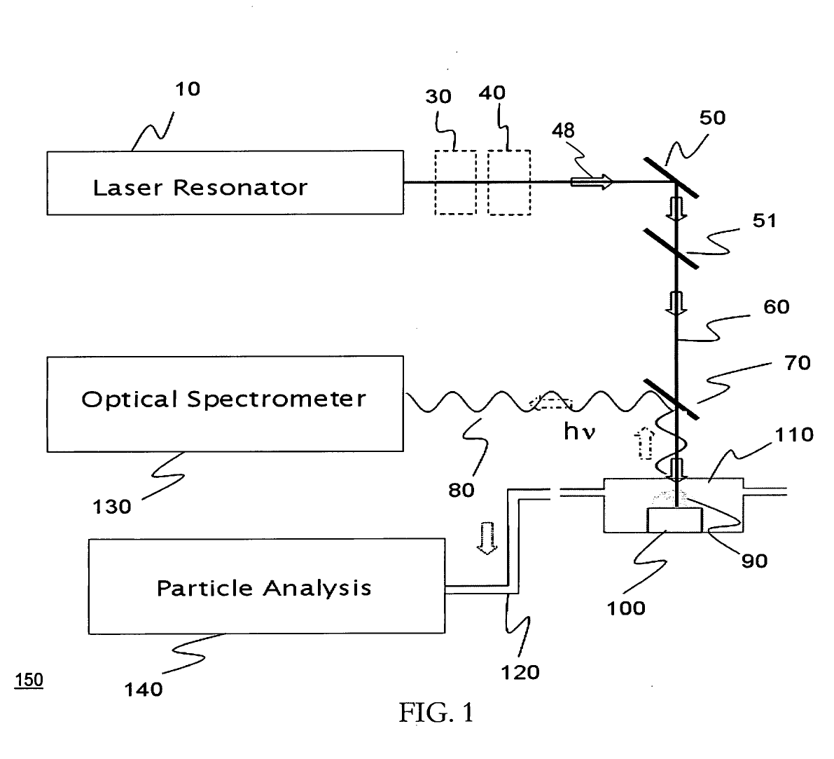

Referring now to FIG. 1, there is shown a simplified architectural diagram illustrating a first embodiment of a LA-LIBS system 150 in a single-laser configuration. The laser system 150 has a first laser resonator 10 that projects a light beam 48 as either a pulse or a continuous wave. The first laser resonator 10 can be implemented with any laser capable of physically interacting with sample material. For example, solid state, gas, dye or other lasers with output power ≧10⁶ W cm⁻² to ≧10¹⁵ W cm⁻². The fundamental wavelength of the first laser resonator 10 may be between 10⁻² to 10¹⁰ nm. However, an initial system operates in the deep UV to mid infra red in the range from 10² to 10⁵ nm. The first laser resonator 10 may be pulsed lasers or continuous wave lasers or any combination of the two.

Although the fundamental wavelength of the laser resonator 10 may span the range as defined above, it is possible and often desirable to modify the laser wavelength prior to sample interaction. This is particularly applicable if the fundamental wavelength of the chosen laser is not compatible with the application. If the wavelength of the first laser resonator 10 requires modification, a first wavelength selection 30 modifies the wavelength generated from the first laser resonator 10 prior to sample interaction. As with wavelength, the width of a first laser pulse 40 may be defined by the fundamental design or may be modified/enhanced to suit the application. A laser pulse may be considered transient if its width is ≦10⁻¹⁵ sec to <10⁻¹ sec.

Bounce mirrors 50 and 51 direct the light beam 48 toward a sample target, but may also be used to filter out unwanted wavelengths of light, collimate the light amplification 48 or provide any other optical enhancement. A two-way mirror 70 designed to pass an incident laser beam 60 to the sample 100 while reflecting a subsequent light 80 emitted by the plasma when the laser photon energy couples to the sample lattice. The emitted light 80 is then directed to an optical spectrometer 130 for analysis.

Laser photon energy is coupled directly to the sample lattice causing a number of physical changes to occur, including the formation of a plasma comprising of electrons, atoms, ions super heated vapor. As energized electrons fall back to their ground state, the energized electrons emit photons of light at specific wavelengths. The emitted light 80 is directed to the optical spectrometer 130 where it is analyzed. A suitable example of the optical spectrometer 130 is a laser induced breakdown spectroscopy. Laser photon energy is coupled directly to the sample lattice causing a number of physical changes to occur, including the formation of a plasma 90. The light from the plasma 90 is directed to the optical spectrometer 130 for analysis

The sample 100 can be selected as any kind of solid or liquid or gas that can be placed inside a sample chamber 110 for analysis. At least one sample or at least one standard is placed in the sample chamber 110. Alternatively, at least one sample and/or at least one standard are placed in the sample chamber 110. Typically, but not exclusively the sample(s)/standards(s) are placed on a motorized stage for targeting. The chamber is designed to transmit laser 60 and emitted light 80 for ablation and analysis as well as effectively transporting a laser generated aerosol 120 for simultaneous or subsequent analysis.

The vaporization that occurs as a result of direct coupling from a high energy pulsed laser 10 in the range of, for example, ≧10⁶ watts to ≧10¹⁵ watts cm⁻², not only generates the plasma 80 but also produces an aerosol 120 composed of condensed vapor and fractured particles from the sample lattice. The aerosol 120 is transported from the sample cell 110 in a gas stream, typically, but not exclusively Argon (Ar) or Helium (He).

The optical spectrometer 130 separates the light into discrete wavelengths. Each element has a unique set of spectral line patterns. The intensity levels for each wavelength are measured and the data is stored. The subsequent spectral data describes the chemical character and composition of the sample analyzed. As the aerosol 120 is generated during this same physical process, LIBS analysis can be performed simultaneously with any of the particle processor 140, including an ICP mass spectrometry (ICP-MS), an ICP optical spectrometry (ICP-OS) and an aerosol trap.

In one embodiment, the optical spectrometer 130 analyzes the laser induced plasma 80 simultaneously with the particle processor 140 that analyzes the laser induced aerosol 120. The term “simultaneously” can be extended broadly to include substantially simultaneous, around the same time, at the same time, or other phrases as a function of time such as “while” that characterize a relationship between the analysis performed by optical spectrometer 130 and the analysis performed by the particle processor 140. In another embodiment, the direct coupling from the high energy pulsed laser 10 to the sample 100 produces the laser induced plasma 80 simultaneous producing the laser ablation aerosol. In a further embodiment, the analysis of the sample material 100 by the optical spectrometer 130 of the laser induced plasma 80 occurred at time t and a subsequent action that is taken later in time at time t+x by the particle processor 140 is considered a single event where the data associated with the laser induced plasma 80 is correlated with the data associated with the laser induced aerosol 120.

In the ICP mass spectrometry, an aerosolized sample is injected into an inductively coupled plasma. The argon plasma is highly energetic with a temperature between 6,000-10,000 degrees Celsius. The aerosol is vaporized, atomized and ionized before being transferred to a high vacuum chamber within the mass spectrometer. As the sampled ions are transported through the mass spectrometer, the sample ions are separated according to their mass to charge ratio (m/e). Once separated, the separated ions hit one or more detectors, the ions are counted and the data is stored for analysis. Both elemental and isotopic information can be acquired at very low levels of detection (<ng/g). The subsequent mass spectral data describes the chemical character and composition of the sample analyzed. In this design, analysis can occur simultaneously to the LIBS in the elements 80, 90 and 130.

In the ICP optical spectrometry, an aerosolized sample is injected into an inductively coupled plasma. The argon plasma is highly energetic with a temperature between 6,000-10,000 degrees Celsius. The aerosol is vaporized, atomized and ionized. As energized electrons fall back to their ground state they emit photons of light at specific wavelengths. This emitted light is directed to the optical spectrometer where it is analyzed. High optical resolution can be obtained with low levels of detection (<μg/g). In this design, analysis can occur simultaneously to LIBS in the elements 80, 90 and 130.

In the aerosol trap, an aerosol generated by laser ablation is captured for analysis. Some trapping methods may include, but are not limited to: (i) bubbling aerosol into an aqueous solution or organic solvent for subsequent digestion and liquid aerosol analysis, (ii) capturing aerosol particles in a filtering device (cellulose filter, glass wool, cascade impacter) for subsequent inspection by optical, electron or atom force microscopy. Particle capture can occur simultaneously to LIBS in the elements 80, 90 and 130.

One of ordinary skill in the art should recognize that the laser aerosol generated and transported by the system 100 will be available to an unlimited number of manipulation, inspection or analytical devices. These analyses can occur simultaneously to LIBS in the elements 80, 90 and 130.

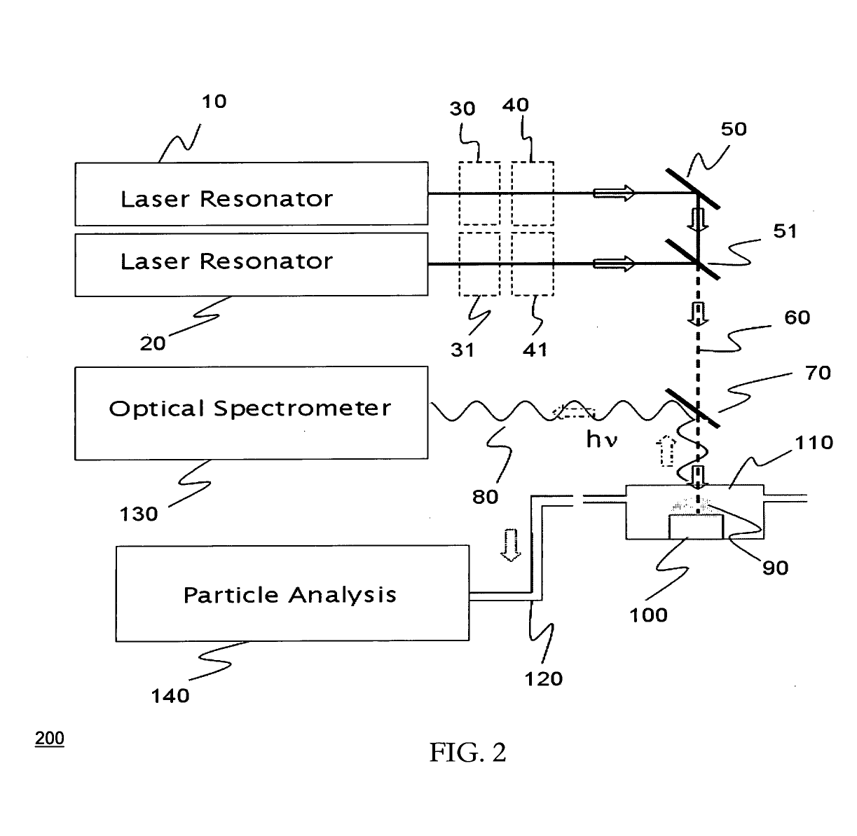

As shown in FIG. 2, there is shown a simplified architectural diagram illustrating a second embodiment of a LA-LIBS system 200 in a two-laser configuration. In addition to the first laser resonator 10, the laser system 200 has a second laser resonator 20 that generates a light beam either as a pulse or a continuous wave. The first laser resonator 10 and the second laser resonator 20 can be implemented with any laser capable of physically interacting with material. For example, solid state, gas, dye or other lasers with output power ≧10⁶ W cm⁻² to ≧10¹⁵ W cm⁻². The fundamental wavelength of the first laser resonator 10 or the second laser resonator 20 may be between 10⁻² to 10¹⁰ nm. However, an initial system will be operating in the deep UV to mid infra red in the range from 10² to 10⁵ nm. Although two laser resonators 10 and 20 are shown in this embodiment, one of skill in the art should recognize that the possibility of incorporating “n” lasers working in concert with one another can be practiced without departing from the spirits of the present invention. The first laser resonator 10 and the second laser resonator 20 may be pulsed lasers or continuous wave lasers or any combination of the two.

Although the fundamental wavelength of the laser resonator 10 or the second laser resonator 20 may span the range as defined above, it is possible and often desirable to modify the laser wavelength prior to sample interaction. This is particularly applicable if the fundamental wavelength of the chosen laser is not compatible with the application. If a first wavelength generated from the first laser resonator 10 requires modification, a first wavelength selection 30 modifies the first wavelength prior to sample interaction. In the two-laser configuration, the second wavelength selection 31 modifies a second wavelength generated from the second laser resonator 20 prior to sample interaction if the second wavelength also requires modification.

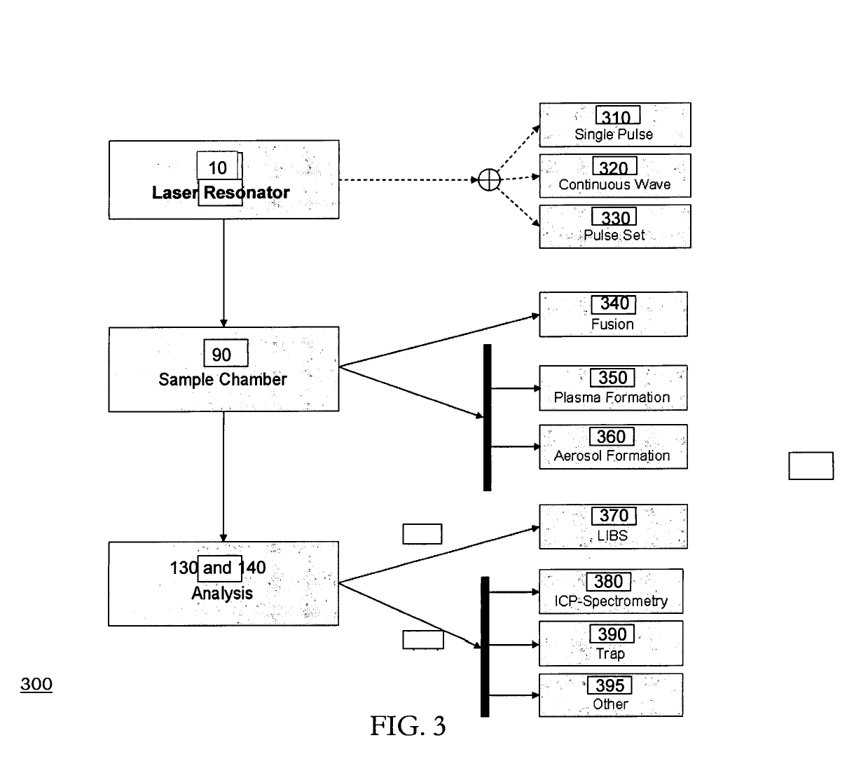

Turning now to FIG. 3, there is a simplified flow diagram 300 illustrating functional processes and options at selected elements in a LA-LIBS system. The laser resonator 10 generates a light amplification by stimulated emission of radiation in producing a pulse width from ≦10⁻¹⁵ seconds to a continuous wave with deep ultra violet to far infra red wavelengths. The laser resonator 10 can generate either a single pulse, a continuous wave, or pulse sets in combination with the laser resonator 20. For a single pulse (SP) 310, a transient laser pulse is typically in the range of ≦10⁻¹⁵ seconds to ≦10⁻¹ seconds with a deep ultra violet to far infra red wavelengths. For a continuous Wave (CW) 320, an uninterrupted laser source is typically at approximately ≧10⁻¹ seconds with deep ultra violet to far infra red wavelengths. For pulse sets 330, any combination of SP and CW laser outputs, or any number of SP laser output or CW laser output, where the timing between pulse sets: SP-SP, SP-CW, CW-SP or CW-CW may be from 10⁻¹² sec to 10¹ seconds or simultaneous. The proper timing between individual pulses within a pulse set are determined by the nature of their physical interaction with the sample such that the quality of the plasma, aerosol or crater is improved relative to isolated pulse combinations.

At the sample chamber 110, a combination of samples or standards can be placed in the enclosed chamber 110 for analysis. Some suitable sampling environments include ambient air (LIBS only), Ar, He or a mixture of gases (LIBS and LA), or may be under vacuum. The laser (light amplification by stimulated emission of radiation) irradiates the sample in the sample chamber 110 to produce either a fusion 340, or a plasma formation 350 or an aerosol formation 360. To produce the fusion 340, the sample is heated with a CW laser before, during or after ablation to collect data for analysis. To produce the plasma formation 350, photon energy at high irradiance (≧10⁶ watts cm⁻² to ≧10¹⁵ watts cm⁻²) is coupled directly to a sample lattice causing a number of physical changes to occur, including the formation of a plasma comprising of electrons, atoms, ions super heated vapor. To produce the aerosol formation 360, the vaporization that occurs as a result of direct coupling from a high energy pulsed laser (≧10⁶ watts to ≧10¹⁴ watts cm⁻²) not only generates the plasma formation 350 but also produces the aerosol 360 comprised of condensed vapor and fractured particles from the sample lattice. The aerosol 360 is transported from the cell in a gas stream, typically, but not exclusively Ar or He.

The analysis portion in FIG. 3, which comprises the analysis by the optical spectrometer 130 and the particle processor 140, provides the ability to simultaneously record and quantify the physical and chemical information derived from the transfer of laser energy into a solid, liquid or gas. This LA-LIBS system 150 or 200 can be easily and quickly configured into a number of variations depending on the requirements of the method.

In a LIBS 370, the energy from a laser pulse is transferred to the sample generating a plasma on the sample surface. The light from that plasma is directed to the optical spectrometer 130 for analysis. The spectrometer separates the light into discrete wavelengths (lines). Each element has a unique set of spectral line patterns. The intensity levels for each wavelength are measured and the data is stored. The subsequent spectral data describes the chemical character and composition of the sample analyzed. As an aerosol is generated during this same physical process LIBS analysis can be performed simultaneously with any of the aerosol analyses in 380, 390 and 395.

In an ICP Spectrometry 380, an aerosolized sample is injected into an inductively coupled plasma. The argon plasma is highly energetic with a temperature typically between 6,000-10,000 degrees Celsius. The aerosol is vaporized, atomized and ionized before being transferred to a high vacuum chamber within a mass spectrometer. As the sampled ions are transported through the mass spectrometer, the sampled ions are separated according to their mass to charge ratio (m/e). Once separated, the sample ions hit a detector(s), where the sample ions are counted and the data is stored for analysis. The subsequent mass spectral data describes the chemical character and composition of the sample analyzed. In this design this analysis can occur simultaneously to LIBS (10).

In a particle trap collection 390, the aerosol is generated by laser ablation then is captured for analysis. Some trapping methods may include, but are not limited to (i) bubbling aerosol into an acidic solution or organic solvent for subsequent digestion and aerosol analysis, and (ii) capturing aerosol particles in a filtering device (cellulose filter, glass wool, cascade impacter) for subsequent inspection by optical, electron or atom force microscopy. Similarly, particle capture can occur simultaneously to the LIBS 370.

Other types of analyses 395 can be practiced without departing from the spirits of the present invention. The laser aerosol generated and transported by the LA-LIBS system 150 or 200 is available to an unlimited number of manipulation, inspection or analytical devices. These analyses can occur simultaneously to the LIBS 370.

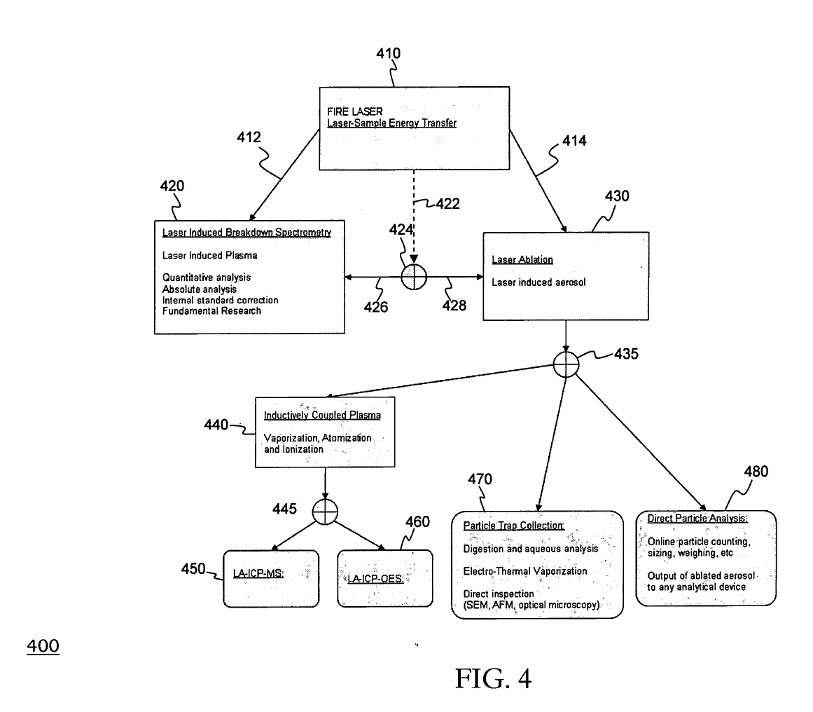

In FIG. 4, there is shown a flow diagram illustrating the process 400 performed by elements in the LA-LIBS 150 system. The laser system 150 can simultaneously operate in LIBS and LA mode or either mode sequentially. In a simultaneous mode, the LA-LIBS system 150 simultaneously records and quantifies the physical and chemical information derived from the transfer of laser energy into a solid, liquid or gas. The LA-LIBS system 150 can be easily and quickly configured into a number of unique variations depending on the requirements of the method. The aerosol generated in LA mode can simultaneously be quantified and/or evaluated by a nearly unlimited number of techniques while acquiring spectroscopic information for the LIBS component.

At block 410, firing a laser sequentially or simultaneously for detecting the emissions which minimizes variations that can occur between laser pulses or when a laser emits a continuous output for a protracted duration. For simultaneous detection, the laser resonator 10 generates a light beam directed onto the sample 100 which produces a laser induced plasma 80 via a path 412 to laser induced breakdown spectrometry at block 420 and produces a laser induced aerosol via a path 414 for transport to laser ablation block 430. Alternatively, the laser resonator 10 generates a light beam directed onto the sample 100 in which the analysis performed by laser induced breakdown spectrometry at block 420 and by laser ablation at block 430 are performed sequentially via a path 422 with a selector 424 that indicates either to pick a path 426 to laser induced breakdown spectrometry at block 420 or via a path 428 to laser ablation at block 430.

The energy from a laser pulse at the LIBS block 420, is transferred to the sample generating a plasma on the sample surface. The light from that plasma is directed to the optical spectrometer 130 for analysis. The spectrometer separates the light into discrete wavelengths. The intensity levels for each wavelength are measured and the data is stored. The subsequent optical spectral data describes the chemical character and composition of the sample analyzed.

The energy from a laser pulse at the LA block 430 is transferred directly into the sample. A plasma forms that comprises atoms, ions, electrons, vapor and particles generated 20 by the interaction of the laser energy with the sample lattice. The micron and sub-micron sized particles produced are transported through hollow tubing by an inert gas stream, typically Argon or Helium, to the analytical devices.

At block 410, firing a laser sequentially or simultaneously for detecting the emissions which minimizes variations that can occur between laser pulses or when a laser emits a continuous output for a protracted duration. For simultaneous detection, the laser resonator 10 generates a light beam directed onto the sample 100 which produces a laser induced plasma 80 via a path 412 to the laser induced breakdown spectrometry at block 420 and produces a laser induced aerosol via a path for transport to the laser ablation at block 430. Alternatively, the laser resonator 10 generates a light beam directed onto the sample 100 in which the analysis performed by the laser induced breakdown spectrometry at block 420 and analysis by the laser ablation at block 430 are performed sequentially via a path 422 with a selector 424 that either picks a path 426 to the laser induced breakdown spectrometry or a path 420 to the laser ablation 430, where the data produced from the analysis by the laser induced breakdown spectrometery at block 420 is correlated with the data produced from the analysis by the laser ablation at block 430. [Lawrence: Can you prepare additional definitions of the word “simultaneous”—“same event”, “correlation of data”, etc.?].

The energy from a laser pulse at the LIB block 420, is transferred to the sample generating a plasma on the sample surface. The light from that plasma is directed to the optical spectrometer 130 for analysis. The light is transferred to a spectrometer through a fiber optic cable. The spectrometer separates the light into discrete wavelengths. Every wavelength has a unique set of spectral lines. The intensity levels for each wavelength are measured and the data is stored. The subsequent optical spectral data describes the chemical character and composition of the sample analyzed.

The energy from a laser pulse at the LA block 430 is transferred directly into the sample causing vaporization. A plasma forms that comprises atoms, ions, electrons and particles removed from the sample. The micron and sub-micron sized particles generated are transported through hollow tubing by an inert gas stream, typically Argon or Helium, to the analytical devices.

The process 400 through a selector 435 picks one of three analyses, a laser ablation inductively coupled plasma 440, a particle trap collection 470, or a direct particle analysis 480. The laser ablation inductively coupled plasma 440 is further divided to an inductively coupled plasma mass spectrometry 450 and an inductively coupled plasma optical emission spectrometry 460. At the inductively coupled plasma mass spectrometry (LA-ICP-MS) 450, an aerosolized sample is injected into an inductively coupled plasma. This argon plasma is highly energetic with a temperature between 6,000-10,000 degrees Celsius. The aerosol is vaporized, atomized and ionized before being transferred to a high vacuum chamber within the mass spectrometer. As the sampled ions are transported through the mass spectrometer they are separated according to their mass to charge ratio (m/e). Once separated they hit the detector(s), are counted and the data is stored for analysis. The subsequent mass spectral data describes the chemical character and composition of the sample analyzed.

At the inductively coupled plasma optical emission spectrometry (LA-ICP-OES) 460, an aerosolized sample is injected into an inductively coupled plasma. This argon plasma is highly energetic with a temperature between 6,000-10,000 degree. An aerosolized sample is injected into an inductively coupled plasma. The aerosol is vaporized, atomized and ionized. During this process electrons are raised from their ground state to higher energy levels. As they fall back to their ground state they emit a photon of light. The plasma is viewed directly and the light emitted from these atoms is directed into the spectrophotometer by a series of optics. The spectrometer separates the light into discrete wavelengths. Every wavelength has a unique set of spectral lines. The intensity levels for each wavelength is measured and the data is stored. The subsequent spectral data describes the chemical character and composition of the sample analyzed.

An aerosol at the aerosol trap 470 is generated by laser ablation is captured for analysis. The aerosol is bubbled into an aqueous or organic solvent for subsequent dissolution and liquid aerosol analysis. The aerosol is captured in a filtering device (cellulose filter, glass wool, etc). The collected material digested in an acidic or organic solvent for subsequent aerosol analysis. The captured particles inspected by optical, electron or atom force microscopy. The captured particles used in further studies.

Aerosol particles at direct particle counting 480 are transferred into a chamber. The laser light hits the particles which then reflect the light onto a photo-detector. A larger particle reflects more light than smaller particles. When properly calibrated the device can size and number of particles passing through the analytical chamber.

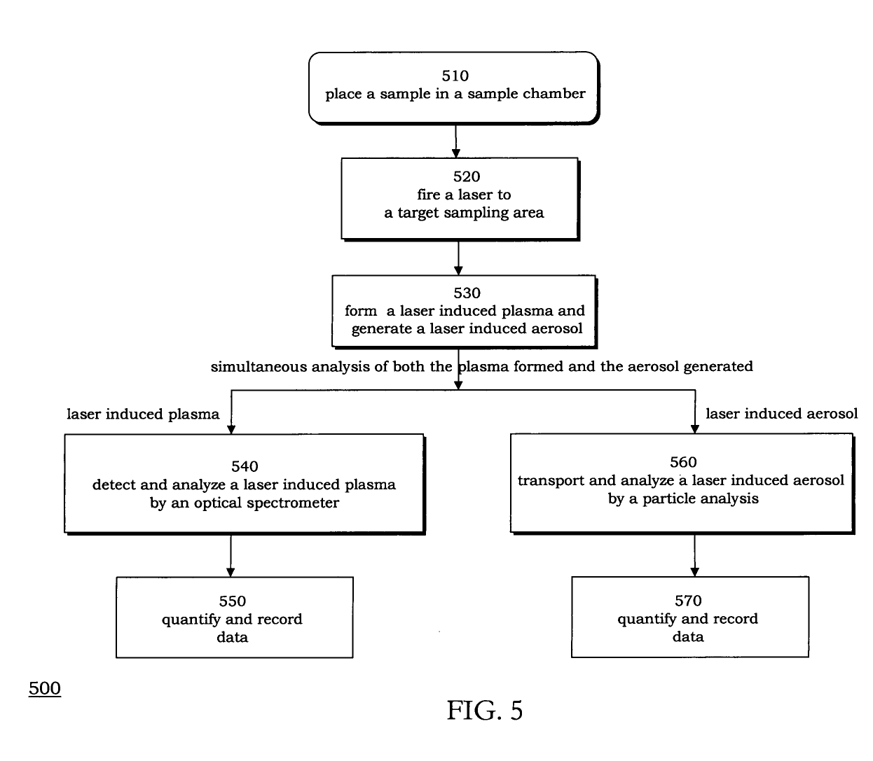

As shown in FIG. 5, there is a flow diagram illustrating the process 500 in conducting a LA-LIBS analysis. At step 510, the process 500 places the sample 100 for material analysis in the sample cell 110. The process 500 at step 520 fires a laser beam from the laser resonator 10 to a targeted area on the sample 100, which in turn produces the plasma formation 80 or the aerosol formation 120. The process 500 simultaneously analyzes the plasma formed 80 by the optical spectrometer 130 at step 540 and the aerosol formed 120 by the particle processor 140. The process 500 then simultaneously quantifies and records the plasma formation 80 at step 550, and quantifies and records the aerosol formation at step 570.

The invention has been described with reference to specific exemplary embodiments. Various modifications, adaptations, and changes may be made without departing from the spirit and scope of the invention. Accordingly, the specification and drawings are to be regarded as illustrative of the principles of this invention rather than restrictive, the invention is defined by the following appended claims.

We claim:

1. A system, comprising:
a sample chamber adapted to hold a sample;
a source of radiation and optics for delivering the radiation to the sample to produce a laser induced plasma formation and a laser induced aerosol formation;
an optical spectrometer for receiving a spectrum of light emitted from the laser induced plasma formation; and
a particle processor for receiving the laser induced aerosol formation or a derivative of the laser induced aerosol formation through a transport coupling between the sample chamber and the particle processor;
wherein the optical spectrometer analyzes chemical data from the laser induced plasma formation while the particle processor analyzes data from the laser induced aerosol formation.

2. The system of claim 1 wherein the optical spectrometer qualifies and records chemical data from the laser induced plasma formation simultaneously with the particle processor qualifies and records data from the laser induced aerosol formation.

3. The system of claim 1 wherein the optical spectrometer quantifies and records chemical data from the laser induced plasma formation simultaneously with the particle processor quantifies and records data from the laser induced aerosol formation.

4. The system of claim 1 wherein the optical spectrometer qualifies and records chemical data from the laser induced plasma formation at the same time the particle processor quantifies and records data from the laser induced aerosol formation.

5. The system of claim 1 wherein the optical spectrometer quantifies and records chemical data from the laser induced plasma formation at the same time the particle processor quantifies and records data from the laser induced aerosol formation

6. The system of claim 1 wherein the optical spectrometer qualifies and records chemical data from the laser induced plasma formation around the same time the particle processor quantifies and records data from the laser induced aerosol formation.

7. The system of claim 1 wherein the optical spectrometer quantifies and records chemical data from the laser induced plasma formation around the same time the particle processor quantifies and records data from the laser induced aerosol formation.

8. The system of claim 1 wherein the optical spectrometer analyzes chemical data from the laser induced plasma formation in a single event that the particle processor analyzes data from the laser induced aerosol formation

9. The system of claim 1 wherein in the single event, the source of radiation produces the laser induced plasma formation simultaneously with producing the laser induced aerosol formation, the optical spectrometer analyzing chemical data from the laser induced plasma at time t, the particle processor collecting data from the laser induced aerosol formation at time t+x, the data associated with the laser induced plasma correlated with the data associated with the laser induced aerosol.

10. The system of claim 1 wherein the optical spectrometer comprises a laser induced breakdown spectrometer.

11. The system of claim 1 wherein the particle processor comprises a LA-ICP mass spectrometry for receiving ions from the laser induced aerosol formation that is vaporized, atomized and ionized.

12. The system of claim 11 wherein the LA-ICP mass spectrometry separates the ions according to their mass charge ratio (m/e), counts the ions by at least one detector and records data.

13. The system of claim 1 wherein the particle processor comprises a LA-ICP optical emissions spectrometry for separating the light into discrete wavelengths such that the intensity levels for each wavelength are quantified and recorded.

14. The system of claim 1 wherein the particle processor comprises a particle trap collection device.

15. The system of claim 1 wherein the particle processor comprises a direct particle analysis device.

16. The system of claim 1 wherein the source of radiation generates a single pulse (SP) or a continuous wave (CW) to the sample.

17. The system of claim 1 wherein the source of radiation comprises a solid-state laser.

18. The system of claim 1 wherein the source of radiation comprises a gas laser.

19. The system of claim 1 wherein the source of radiation comprises a first laser resonator for generating a first radiation to the sample and a second laser resonator for generating a second radiation to the sample, wherein the first radiation generated from the first laser resonator and the second radiation generated from the second laser resonator comprises a pulse set such that the pulse set includes a SP-SP combination, SP-CW combination, a CW-SP combination, or a CW-CW combination.

20. The system of claim 19 wherein the first radiation and the second radiation having a timing relationship between individual pulses within a pulse set that are determined by the nature of their physical interaction with the sample such that the quality of the plasma, aerosol or crater is improved relative to isolated pulse combinations.

21. The system of claim 1 wherein the optical spectrometer comprises a spectrophotometer

22. A method for material analysis of a sample in a system, comprising:
delivering a radiation on a sample in a sample chamber from a source of radiation, thereby producing a laser induced plasma formation and producing a laser induced aerosol formation; and
analyzing the laser induced plasma formation by an optical spectrometer (a.k.a. spectrophotometer) while analyzing the laser induced aerosol formation by a particle processor.

23. The method of claim 22 wherein the analyzing step comprises qualifies and records chemical data from the laser induced plasma formation by the optical spectrometer simultaneously with the particle processor quantifies and records data from the laser induced aerosol formation.

24. The method of claim 23 wherein the analyzing step comprises quantifying and recording chemical data from the laser induced plasma formation by the optical spectrometer.

25. The method of claim 24 wherein the analyzing step comprises quantifying and recording data from the laser induced aerosol formation by the particle processor.

26. The method of claim 25 wherein the optical spectrometer comprises a laser induced breakdown spectrometer.

27. The method of claim 22 wherein the particle processor comprises a LA-ICP mass spectrometry.

28. The method of claim 22 wherein the particle processor comprises a LA-ICP optical emissions spectrometry.

29. The method of claim 22 wherein the particle processor comprises a particle trap collection device.

30. The method of claim 22 wherein the particle processor comprises a direct particle analysis device.

31. The method of claim 22 wherein the optical spectrometer comprises a spectrophotometer.
